(19) United States
(12) Patent Application Publication
(10) Pub. No.: US 2010/0042836 A1
(43) Pub. Date: Feb. 18, 2010

(54) METHOD FOR SECURELY TRANSMITTING DEVICE MANAGEMENT MESSAGE VIA BROADCAST CHANNEL AND SERVER AND TERMINAL THEREOF

(75) Inventors: Min-Jung Shon, Seoul (KR); Sung-Mu Son, Seoul (KR); Seung-Jae Lee, Seoul (KR); Youn-Sung Chu, Seoul (KR); Te-Hyun Kim, Seoul (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 12/514,526

(22) PCT Filed: Oct. 24, 2007
(86) PCT No.: PCT/KR07/05253

§ 371 Date: Oct. 19, 2009

Related U.S. Application Data
(60) Provisional application No. 60/858,363, filed on Nov. 13, 2006.

(30) Foreign Application Priority Data
Jul. 20, 2007 (KR) 10-2007-0073020

(51) Int. Cl. H04L 9/32

(52) U.S. Cl. 713/168; 726/6

(57) ABSTRACT

A secure transmission of a device management message via a broadcast (BCAST) channel, by which a BCAST server can securely transmit a device management message including an authentication value to a plurality of terminals via a one way BCAST channel, and accordingly the terminals is not required to use a separate channel for authenticating the device management message received from the BCAST server.

### TECHNICAL FIELD

The present disclosure relates to subject matter contained in priority U.S. Provisional Application No. 60/858,363, filed on Nov. 13, 2006 and Korean Application No. 10-2007-0073020, filed on Jul. 20, 2007, which are herein expressly incorporated by reference in its entirety.

The present invention relates to a broadcast (hereafter, referred to as ‘BCAST’) and a device management (DM), and particularly, to securely transmitting DM messages via a broadcast channel.

### BACKGROUND ART

A broadcast service refers to a service for providing broadcasting or various additional information via mobile terminals. The broadcast service denotes a new type of service for a mobile terminal which includes both a broadcast service by which a service provider provides all subscribers subscribed to his services with useful information, and a multicast service by which a service provider provides various information only to a certain group of subscribers each subscribed to a particular subject or content.

A Device Management (DM) technology is typically based on bidirectional protocol and one-to-one communication protocol by which a DM server exchanges DM messages with DM clients (hereafter, referred to as ‘terminal’) via DM sessions. The DM server must establish a DM session in order to transfer a DM command to the terminal. Thus, the DM server may send a DM session notification message to the terminal in a PUSH manner in order to establish the DM session. Here, when the terminal having received the message accesses the DM server to request for a DM session connection, the DM session can be established between the terminal and the DM server.

Recently, a BCAST server may provide BCAST services to terminals via a BCAST channel as a one way channel. Therefore, when the BCAST server (i.e., corresponding to a DM server from a DM perspective) sends a DM message to terminals, the DM message may be sent from the BCAST server to the terminals via the BCAST channel. However, from the perspective of the terminal, it should be authenticated (certified) whether the DM message received via a BCAST channel is available(validate, or appropriate) for the terminal. To this end, a separate channel is required to authenticate (certify) whether a DM message exchanged between the DM server and the terminal is available(validate, or appropriate) for the terminal.

As such, the related art BCAST server sends a DM message via a one way BCAST channel, which requires a separate channel to be allocated for a message authentication. If the separate channel is allocated to authenticate the DM message, it may decrease channel efficiency as well as waste channel resource.

### DISCLOSURE OF INVENTION

### Technical Solution

Therefore, an object of the present invention is to provide a method for authenticate (certify) validity of a DM message even sent via a one way channel, and a server and terminal thereof.

Another object of the present invention is to include a timestamp in a DM message sent from a BCAST server to a terminal via a one way channel, so as to increase efficiency when determining validity of the DM message.

To achieve these and other advantages and in accordance with the purpose of the present invention, as embodied and broadly described herein, there is provided a method for transmitting a message between devices comprising: transmitting a message including a first authentication value from a server to at least one terminal via a specific channel; receiving the message by the terminal to generate a second authentication value; and to thereafter compare the first authentication value with the generated second authentication value.

Preferably, the comparing step may comprise determining the message to be available when the first authentication value is equal to the second authentication value, and determining the message not to be available when the first authentication value is different from the second authentication value.

Preferably, the comparing step may further comprise executing the message when it is determined the message is available, and revoking the message when it is determined the message is not available.

In another aspect of the present invention, a method for securely transmitting a message in a BCAST service may comprise: transmitting, by a server, a message which includes a first authentication value generated based upon a specific algorithm to at least one terminal via a broadcast channel; generating a second authentication value using the received message based upon the specific algorithm in the terminal; and comparing the first authentication value with the second authentication value.

In another aspect of the present invention, a server may comprise: an authentication managing unit adapted to generate an authentication value; a message generating unit adapted to generate a device management message including at least one of the generated authentication value and a timestamp; and a transceiving unit adapted to transmit the generated message to at least one terminal via a broadcast channel.

In another aspect of the present invention, a terminal may comprise: a transceiving unit adapted to receive a device management message including a first authentication value via a broadcast channel; and a controlling unit adapted to generate a second authentication value using the received device management message, extract the first authentication value from the device management message, and compare the first authentication value with the second authentication value.

In another aspect of the present invention, a method for securely transmitting a message in a BCAST service may comprise: receiving a device management message including at least a first authentication value from a server; generating a second authentication value using the device management message based upon a specific algorithm; extracting the first authentication value from the device management message; and comparing the first authentication value with the second authentication value.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a block diagram of a BCAST server and a terminal in accordance with one embodiment of the present invention; and

FIG. 2 is a block diagram illustrating a configuration of a device management message and a method for securely transmitting the device management message in accordance with one embodiment of the present invention.

### MODE FOR THE INVENTION

The present invention may be applied to a Broadcasting (BCAST) system and a Device Management (DM) system, but not be limited to those systems. The present invention can be applied to other technical fields to which the technical scope of the present invention is applicable.

The present invention conceptually relates to securely transmitting a DM message including an authentication value from a BCAST server to a plurality of terminals via a one way BCAST channel. That is, the present invention may not require a separate channel used to authenticate (certify) the DM message received by the terminals from the BCAST server.

In more detail, according to the present invention, first, a BCAST server may include in a DM message a first authentication value (e.g., a signature value generated based upon RSA-RSS algorithm) and a timestamp, and then sends the DM message to at least one terminal via a one way channel (e.g., BCAST channel) or a bidirectional channel (e.g., an interaction channel). Second, the terminal may receive the DM message to generate a second authentication value (e.g., a signature value generated based upon the RSA-RSS algorithm). Third, when comparing the first authentication value with the second authentication value and the two authentication values are equal to each other, the terminal may determine that the DM message received is available (validate) and thusly executes the DM message. On the other hand, when the authentication values are not equal to each other, the terminal may determine that the DM message received is not available (validate), and may thereby revoke the received DM message. Fourth, the timestamp included in the DM message may be used to determine whether a message received is equal to a previously received message. The timestamp may be generated by another entity other than the BCAST server.

Description will now be given in detail of embodiments of the present invention, with reference to the accompanying drawings.

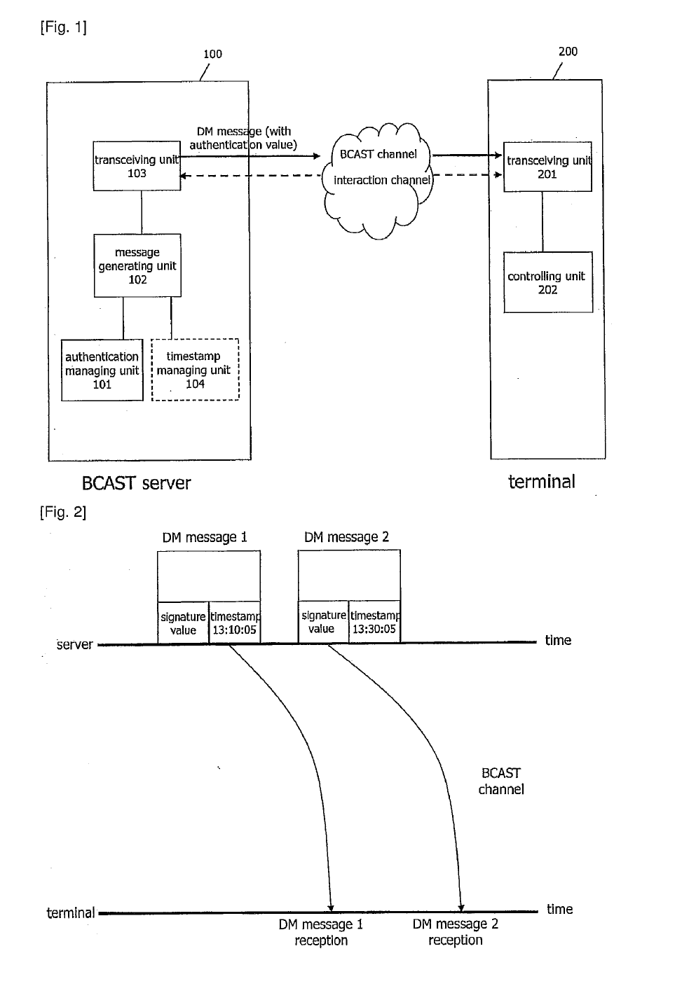

FIG. 1 is a block diagram of a BCAST server and a terminal in accordance with one embodiment of the present invention. A wireless channel through which a DM message is transferred is implemented as one way channel in FIG. 1. Alternatively, the wireless channel can be implemented as an interaction channel.

As illustrated in FIG. 1, a BCAST server 100 according to the present invention may comprise an authentication managing unit 101 adapted to generate an authentication value (e.g., a signature value), a message generating unit 102 adapted to generate a DM message, a transceiving unit 103 adapted to transmit the generated DM message to at least one terminal 200 via a one way channel (e.g., BCAST channel or OMA BCAST TP-5 channel) or a bidirectional channel (e.g., an interaction channel), and a timestamp managing unit 104 adapted to generate a timestamp. The timestamp managing unit 104 may be configured in an independent entity other than in the BCAST server 100.

Also, the terminal 200 according to the present invention may comprise a transceiving unit 201 adapted to receive a DM message sent by the BCAST server 100, and a controlling unit (or comparing/determining unit) adapted to generate an authentication value (i.e., an authentication value generated by the terminal) using the received DM message, extract an authentication value (i.e., an authentication value generated by the server) included in the DM message, and compare the extracted authentication value with the generated authentication value to determine whether the authentication values are equal to each other.

Here, the terms of the components of the BCAST server 100 and the terminal 200 may not be limited to the terms, but be applied to all components which can perform their functions. Also, they may be applied to other components having combined functions of each component.

Hereinafter, functions and operations of components of the present invention will be described.

The BCAST server 100 may transmit a DM message including an authentication value to the terminal 200 via a one way channel in order to securely transmit the DM message. The authentication managing unit 101 may generate a first authentication value (i.e., an authentication value generated by a server) to be included in the DM message based upon a specific algorithm such as RSA-RSS. Here, the authentication managing unit 101 may generate the first authentication value depending on other algorithms other than the RSA-RSS. Here, the first authentication value may be a signature value, for example.

The message generating unit 102 may receive the first authentication value from the authentication managing unit 101 and include the first authentication value in a DM message, thereby generating a message (i.e., a security-ensured DM message) to be transmitted to the terminal 200. Also, the message generating unit 102 may generate the DM message by further including a timestamp therein. Here, the timestamp may be generated by the timestamp managing unit 104. The timestamp may include time information as to when a certain DM message is generated.

As such, the DM message generated by the message generating unit 102 is illustrated in FIG. 2. That is, the DM message may include the first authentication value (i.e., the signature value) as information for the device management, and may optionally include the timestamp.

The DM message generated by the message generating unit 102 may be transferred to the transceiving unit 103. The transceiving unit 103 may then forward the DM message to the terminal 200 via a one way channel (e.g., BCAST channel or TP-5). In the manner described above, the BCAST server 100 can transmit a series of DM messages (i.e., DM messages each including a signature value and a timestamp) to the terminal 200.

The transceiving unit 201 of the terminal 200 receives the DM message transmitted by the BCAST server 100. The controlling unit 202 may extract the first authentication value (i.e., the signature value generated by the server based upon RSA-RSS) from the received DM message. The controlling unit 202 may then generate a second authentication value (i.e., a signature value) using the received DM message based upon the RSA-RSS algorithm, and compare the first authentication value with the second authentication value to determine their correspondence. Here, the RSA-RSS algorithm may be the same as the algorithm used by the BCAST server for generating the first authentication value. If the algorithm is different from the algorithm used by the BCAST server for generating the first authentication value, the terminal 200 should generate the second authentication value based upon the same algorithm as that used by the BCAST server 100.

According to the result of the comparison between the first authentication value and the second authentication value, if the authentication values are equal to each other, the controlling unit 202 may determine that the received DM message is available (validate), and thusly execute DM information included in the DM message. However, if the two authentication values are not equal to each other according to the result of the comparison, the controlling unit 202 may determine that the DM message is not available, and thereby revoke the message. Here, the revocation may mean ‘delete’, ‘ignore’ or ‘return’ of the message.

In addition, the controlling unit 202 may extract the timestamp if it is included in the received DM message. The controlling unit 202 may then determine whether the received DM message is the same as a previously received DM message using time information included in the timestamp. For example, as illustrated in FIG. 2, it is assumed that the terminal 200 has received a DM message 2 after a DM message 1 was received. As one example, time information included in the timestamp of the DM message 1 may be ‘13:10:05’ (hh:mm:ss) and time information included in the timestamp of the DM message 2 may be ‘13:30:05’. The timestamp may also include information related to year and date; however, those information may be omitted in the present invention for the sake of brief description. Therefore, the time difference between the generation times of the DM messages 1 and 2 apparently goes to 20 minutes.

The controlling unit 202 of the terminal 200 may check the time information (e.g., ‘13:30:05’ of FIG. 2) in the time stamp so as to determine whether to execute the received DM message 2. Assuming that a tolerance (threshold) of a timestamp has been set to 30 minutes, the DM message 1 and the DM message 2 may be considered as the same message. Accordingly, the controlling unit 202 may revoke the DM message 2. Here, the tolerance (threshold) of the timestamp may act as a criterion for determining whether a DM message received by the terminal 200 is the same as a previously received message.

As described above, the present invention can securely transmit a DM message from a BCAST server to a terminal, for example, via a one way channel. Therefore, it is effective to ensure security of the DM message even if it is transmitted via the one way channel.

In addition, since a DM message including an authentication value may be transmitted from a BCAST server to a terminal via one way channel or an interaction channel, it is effective to determine whether the DM message is available using the authentication value.

Furthermore, since a DM message including a timestamp is transmitted from a BCAST server to a terminal via one way channel, it is effective to determine whether the DM message is equal to a previously received message and the DM message should be executed based upon time information in the timestamp.

To implement the methods described above, the present invention can employ hardware, software or combination thereof. For example, the methods according to the present invention may be stored in a storage medium (e.g., an internal memory in a mobile terminal, a flash memory, a hard disc, etc.), or may be implemented as codes or commands within a software program which can be operated by a processor (e.g., a microprocessor in a mobile terminal).

The foregoing embodiments and advantages are merely exemplary and are not to be construed as limiting the present disclosure. Many alternatives, modifications, and variations will be implemented without departing from the characteristics of the present invention and within the scope as defined in the appended claims. For example, a server and a terminal in the present invention may be implemented as one device, and a DM message transmitted from the server to the terminal may be a specific message which functions as the DM message. Therefore, the present invention can be applied to both method and apparatus for securely transmitting a message between devices.

1. A method for transmitting a message between devices comprising:
transmitting a message including a first authentication value from a server to at least one terminal via a specific channel;
receiving the message by the terminal to generate a second authentication value; and
comparing the generated second authentication value with the first authentication value.

2. The method of claim 1, wherein the comparing step comprises:
determining that the message is available when the first authentication value is equal to the second authentication value, and determining that the message is not available when the first authentication value is different from the second authentication value.

3. The method of claim 2, wherein the comparing step further comprises:
executing the message when it is determined the message is available, and revoking the message when it is determined the message is not available.

4. The method of claim 1, wherein the message is generated by the server and used for a device management by the terminal.

5. The method of claim 1, wherein the message further comprises a timestamp generated by the server.

6. The method of claim 1, wherein the specific channel is a broadcast channel or one way channel through which the message is transmitted from the server to the terminal.

7. The method of claim 1, wherein the specific channel is an interaction channel between the server and the terminal.

8. The method of claim 1, wherein the first and second authentication values are signature values.

9. The method of claim 8, wherein the first and second authentication value are generated using a RSA-RSS algorithm.

10. A method for securely transmitting a message in a broadcasting service comprising:
including by a server a first authentication value generated using a specific algorithm in a message and transmitting the message to at least one terminal via a broadcast channel;
generating by the terminal a second authentication value using the specific algorithm; and
comparing the first authentication value with the second authentication value by the terminal.

11. The method of claim 10, wherein the message is a device management message.

12. The method of claim 10, wherein the specific algorithm is a RSS algorithm to be used for generating the first authentication value and the second authentication value.

13. A server comprising:
an authentication managing unit adapted to generate an authentication value;
a message generating unit adapted to generate a device management message including at least one of the generated authentication value and a timestamp; and
a transceiving unit adapted to transmit the generated message to at least one terminal via a specific channel.

14. The server of claim 13, wherein the authentication managing unit generates the authentication value using a RSS algorithm.

15. The server of claim 13, further comprising a timestamp managing unit adapted to generate the timestamp.

16. The server of claim 15, wherein the timestamp managing unit is an independent entity which is not configured in the server, or
the timestamp managing unit is configured in the server.

17. The server of claim 13, wherein the specific channel is either a broadcast channel or one way channel or an interaction channel.

18. A terminal comprising:
a transceiving unit adapted to receive a device management message including a first authentication value via a specific channel; and
a controlling unit adapted to generate a second authentication value using the device management message, extract the first authentication value from the device management message, and compare the first authentication value with the second authentication value.

19. The terminal of claim 18, wherein the controlling unit extracts a timestamp from the device management message.

20. The terminal of claim 18, wherein the controlling unit generates the second authentication value using a RSA-RSS algorithm.

21. The terminal of claim 20, wherein the RSA-RSS algorithm is the same one to be used for generating the first authentication value.

22. The terminal of claim 18, wherein the controlling unit determines that the device management message is available when the first authentication value is equal to the second authentication value, and then executes the device management message.

23. The terminal of claim 18, wherein the controlling unit determines that the device management message is not available when the first authentication value is not equal to the second authentication value, and then revokes the device management message.

24. The terminal of claim 18, wherein the controlling unit determines whether the device management message is the same as a previously received message by analyzing the timestamp extracted from the device management message.

25. The terminal of claim 18, wherein the specific channel is one of a broadcast channel, one way channel and an interaction channel.

26. A method securely transmitting a message in a broadcasting (BCAST) service comprising:
receiving a device management message including at least a first authentication value from a server;
generating a second authentication value using the device management message based upon a specific algorithm;
extracting the first authentication value from the device management message; and
comparing the first authentication value with the second authentication value.

27. The method of claim 26, further comprising: executing the device management message when the first authentication value is equal to the second authentication value.

28. The method of claim 26, further comprising:
revoking the device management message when the first authentication value is not equal to the second authentication value.
